(19) United States
(12) Patent Application Publication
(10) Pub. No.: US 2005/0259601 A1
(43) Pub. Date: Nov. 24, 2005

(54) Video conferencing over public network

(75) Inventors: Ofer Rosenberg, Yokneam Ilit (IL); Abraham Fisher, Haifa (IL)

Correspondence Address: WOLF, BLOCK, SCHORR & SOLIS-COHEN LLP, 250 PARK AVENUE, NEW YORK, NY, 10177, US

(73) Assignee: Surf Communication, Yokneam (IL)

(21) Appl. No.: 11/131,868

(22) Filed: May 18, 2005

(30) Foreign Application Priority Data
May 19, 2004 (IL) 162075

(51) Int. Cl. H04L 12/66; H04L 12/16; H04Q 11/00

(52) U.S. Cl. 370/260; 370/352

(57) ABSTRACT

A method of handling video signals by a gateway. The method includes receiving by a gateway between a land cellular network and a public switched telephone network, video signals of a real time session, from an end unit, reducing the rate of the video signals, by the gateway and transmitting the rate reduced video signals onto a channel passing through a public switched telephone network.

### FIELD OF THE INVENTION

The present invention relates to communication systems and in particular to systems for handling transmission of video signals over a public switched telephone network.

### BACKGROUND OF THE INVENTION

For many years it has been desired to perform video telephone conversations. Generally, video telephone conversations required a dedicated broadband link between the parties of the conversation.

The H.324 standard defines a signal format for transmitting video signals over modem links of 28,800 bits per second (bps). The video quality transmitted in accordance with the H.324 standard is, however, relatively low and therefore the H.324 standard did not succeed in the market. For a display window of 176×132 pixels, the H.324 standard achieved a frame rate of only 4-12 frames per second.

The 3G-324M standard (also known as H.324M) defines a signal format for transmitting video and audio signals between cellular telephones and other entities (video servers) within a third generation (3G) network. The 3G-324M standard uses a 64K bit rate and thus can achieve more than twice the quality of the H.324 standard.

The public switched telephone network (PSTN) defines telephone channels of 64 Kbps. The PSTN, however, suffers from various imparities, including digital attenuation pads, robbed bit signaling and PCM skew.

A paper titled “Video Conferencing over 3G-324M Enabled Networks” downloaded from www.teamsolutions.co.uk/ts3g-324m.html on Apr. 29, 2004, describes performing video conferencing in accordance with the 3G-324M standard between a cellular telephone and a terminal outside the cellular telephone network. A gateway converts the 3G-324M signals into IP signals in accordance with the H.323 standard. In order to achieve acceptable quality, the IP signals must pass on a broadband network, such as an Ethernet network or an ADSL line. The conversion between the 3G-324M signals and the H.323 signals is relatively computation intensive and therefore requires relatively expensive gateways for performing the conversion.

A paper titled “3G-324M Helps 3G Live up to its Potential”, by Eli Orr, dated March 2004, and downloaded from www.wsdmag.com on Apr. 29, 2004, states that 3G-324M signals could also be passed over the public switched telephone network (PSTN) over leased ISDN lines. Leased ISDN lines, however, are expensive, as users must pay for the leased lines without relation to their use.

### SUMMARY OF THE INVENTION

An aspect of some embodiments of the present invention relates to adapting (e.g., reducing) the rate of standard video conferencing signals, on passing from a cellular network to a non-dedicated PSTN connection. While protocols that are planned to be used on the PSTN have a low bit rate and therefore have a relatively low quality, standards for use on 3G networks use a high bit rate, which cannot be passed on non-dedicated PSTN connections. Reducing the bit rate of the video signals when passing from the cellular network to the PSTN, allows fitting the video signals to the actual bit rate of the non-dedicated PSTN connection. Thus, at least for high quality non-dedicated PSTN connections, such as all digital connections or maximum rate analog to digital connections, the quality of the video signals passed over the PSTN is close to (or even identical to) the quality of the video signals passing on the cellular network. The slight degradation due to the rate adaptation is considered by the inventors to be worthwhile in order to achieve the video conferencing without requiring dedicated ISDN, ADSL or other dedicated communication lines.

In an exemplary embodiment of the invention, the video conferencing signals are in accordance with the 3G-324M standard.

The rate adaptation optionally includes dropping a frame when necessary, for example dropping a frame per second (e.g., 1 out of 24 frames). The receiver optionally uses an immediately previous frame or an interpolation between previous and following frames in order to fill in instead of the dropped frame. Alternatively or additionally, the rate adaptation includes compressing the headers of the video conferencing signals. In some embodiments of the invention, the rate adaptation takes into account the higher reliability of the PSTN relative to wireless links of a cellular network. For example, header fields required for reliability may be dropped or allocated fewer bits, on the PSTN.

In an exemplary embodiment of the invention, the non-dedicated PSTN connection passes entirely on one or more PCM links. PCM links have a theoretical rate of 64 Kbps, which is reduced by one or more imparities of digital attenuation pads, robbed bit signaling and PCM skew, to about 61-62 Kbps. The PCM links generally pass to end-clients on E1 and/or T1 lines. For such connections, the reduction in quality is at most about 5%, and if header compression methods are used, lower loss rates are achieved.

An aspect of some embodiments of the present invention relates to transmission of standard video conferencing signals of a bit rate larger than 40 Kbps on a non-dedicated (e.g., not ISDN) all-digital connection through a PSTN. Optionally, the video conferencing signals are transmitted over a VBM connection. Alternatively or additionally, any other connection management which overcomes the imparities of the PSTN, including digital attenuation pads, robbed bit signaling and/or PCM clock timing problems (e.g., clock skew), is used.

In some embodiments of the invention, the use of an all-digital connection on the PSTN for video conferencing at bit rates above 40 Kbps, and especially above 48 Kbps, requires employing modem hardware and/or software which is generally not required for data services by clients having all-digital connections. Clients having all-digital connections generally utilize broadband connections for data services and therefore do not employ voice band modems or other apparatus for data transmission over PCM links. In some embodiments of the invention, the use of modem apparatus for transferring video conferencing signals is preferred over converting the video signals into a format suitable for transmission over broadband. The conversion into a broadband format adds delay and requires more processing power than a modem connection.

There is therefore provided in accordance with an exemplary embodiment of the invention, a method of handling video signals by a gateway, comprising receiving, by a gateway between a land cellular network and a public switched telephone network, video signals of a real time session, from an end unit, reducing the rate of the video signals, by the gateway, and transmitting the rate reduced video signals onto a channel passing through a public switched telephone network.

Optionally, the received video signals are compressed by the end unit. Optionally, the received video signals have a bit rate greater than 46 Kbits per second. Optionally, the received video signals have a bit rate of about 64 Kbits per second. Optionally, the received video signals have a bit rate which can fit on the nominal bit rate of the public switched telephone network. Optionally, the end unit comprises a mobile unit. Optionally, the received video signals are in accordance with the 3G-324M standard. Optionally, reducing the rate of the video signals comprises dropping signal portions of the received video signals.

Optionally, transmitting the rate reduced signals comprises transmitting over a channel suffering from at least one of digital attenuation pads, robbed bits and PCM clock skew. Optionally, reducing the rate of the video signals comprises compressing headers of packets of the video signals. Optionally, the received signals are in accordance with a standard format and the rate reduced signals are also according to the standard format. Alternatively, the received signals are in accordance with a standard format and the rate reduced signals are not according to the standard format.

Optionally, transmitting the rate reduced signals onto the channel comprises transmitting over a voice band modem connection. Optionally, transmitting the rate reduced signals comprises transmitting over an all digital modem connection over a PCM channel. Optionally, transmitting the rate reduced signals comprises transmitting over a non-dedicated channel of the public switched telephone network.

There is further provided in accordance with an exemplary embodiment of the invention, a method of handling video signals by a gateway, comprising receiving, by a gateway between a land cellular network and a public switched telephone network, video signals having a bit rate greater than 42 Kbps for both upstream and downstream transmissions, and transmitting the video signals onto a modem connection passing through an all digital PCM link of a public switched telephone network.

Optionally, the received video signals have a bit rate greater than 48 Kbps. Optionally, the method includes reducing the rate of the received video signals before transmitting the video signals on the modem connection. Optionally, transmitting the video signals onto a modem connection comprises transmitting on a V.91 modem connection.

There is further provided in accordance with an exemplary embodiment of the invention, a gateway to a public switched telephone network for video signals, comprising a video interface, for receiving video signals of a real time session, a rate adaptation unit adapted to reduce the rate of the video signals received by the video interface, and a PSTN interface for transmitting the reduced rate video signals onto a channel passing through a public switched telephone network. Optionally, the video interface is adapted to receive signals of the real time session at a rate greater than 33.6 Kbps in at least the upstream or downstream direction.

Optionally, the video interface is adapted to receive signals in accordance with the 3G-324M standard. Optionally, the rate adaptation unit is adapted to drop video frames of the session. Optionally, the rate adaptation unit is adapted to increase the rate of video conferencing signals received through the PSTN interface and passed to through the video interface. Optionally, the PSTN interface comprises a VBM modem. Optionally, the PSTN interface comprises an all-digital modem. Optionally, the video interface comprises an interface to a land cellular network. Optionally, the video interface comprises an interface to a private network. Optionally, the video interface is adapted to receive signals from a circuit switched emulated network. Optionally, the video interface is adapted to receive signals having a signal rate 1-20% greater than the actual capacity of the channel passing on the PSTN.

There is further provided in accordance with an exemplary embodiment of the invention, a gateway of video signals a public switched telephone network, comprising a video interface, for receiving video signals of a real time session, at a rate greater than 42 Kbps, a modem adapted to establish an all-digital connection over a PCM link of a public switched telephone network and a PSTN interface for transmitting the received video signals over the all-digital connection established by the modem.

Optionally, the video interface receives signals at a rate greater than 48 Kbps.

### BRIEF DESCRIPTION OF FIGURES

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a video conference connection, in accordance with an exemplary embodiment of the present invention; and

FIG. 2 is a flowchart of acts performed by a rate adapter, in accordance with an exemplary embodiment of the present invention.

### DETAILED DESCRIPTION OF EMBODIMENTS

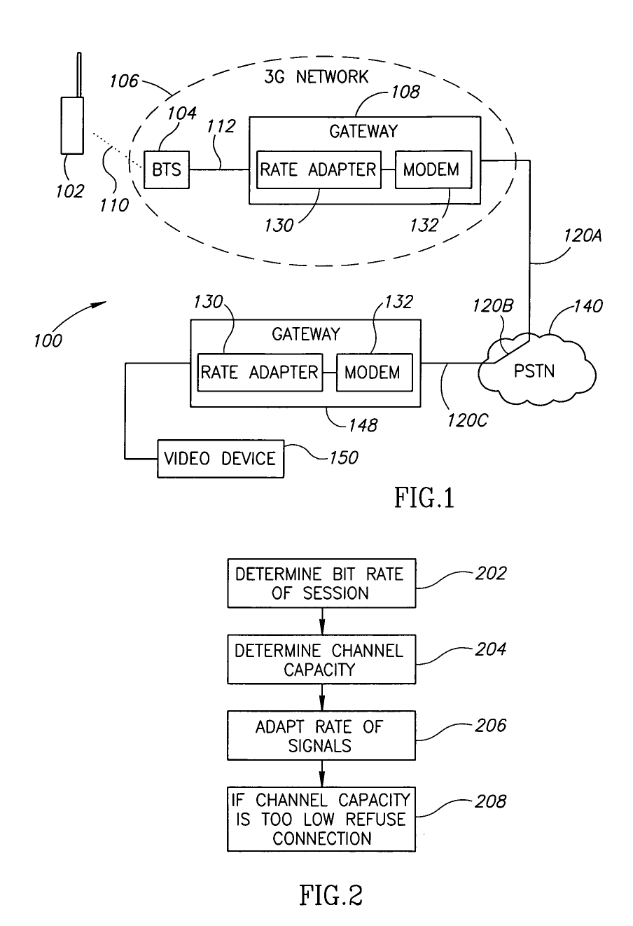

FIG. 1 is a schematic illustration of a video conference connection 100, in accordance with an exemplary embodiment of the invention. Video conferencing connection 100 optionally carries real time video signals (which may include combined video and audio signals) passing in both upstream and downstream directions between a cellular mobile unit 102 and a video device 150.

A first segment of connection 100 passes on a wireless link 110 between cellular mobile unit 102 and a base station (BTS) 104 of a terrestrial network 106, for example, a third generation (3G) network. A second segment 112 of connection 100 passes within network 106, between BTS 104 and a gateway 108. A third segment of connection 100 passes on PCM channels 120A, 120B and 120C (referred to together as channel 120) known in the art, which form the PSTN and the connections thereto. Alternatively, channel 120C is an analog link, for example a twin pair copper line. Channel 120 leads from gateway 108, which interfaces between terrestrial network 106 and PSTN 140, to a gateway 148 that interfaces an end video device 150 to PSTN 140. Video device 150 is not connected directly to terrestrial network 106 but is rather connected through PSTN 140.

Gateway 148 optionally services a single video device 150. Alternatively, gateway 148 services a plurality of video devices. In some embodiments of the invention, gateway 148 is located in a private location, such as the residence of office of the owner of video device 150. Alternatively or additionally, one or more video devices 150 are serviced by gateways 148 provided by an operator of PSTN 140.

Video conferencing signals transmitted and received by video device 150 and mobile unit 102 are optionally in the 3G-324M format. Alternatively, video device 150 is adapted to communicate using a different video format, such as the session initiation protocol (SIP) or the H.323 protocol suite. In accordance with this alternative, gateway 148 converts the 3G-324M signals into the format recognized by video device 150, and vice versa. Further alternatively, the conversion between formats is performed by gateway 108 or by a dedicated format converter (not shown) located between the gateways and/or between gateway 148 and video device 150.

The video conferencing signals passing on the first and second segments 110 and 112 of connection 100 are optionally also in the 3G-324M format. In some embodiments of the invention, each of gateways 108 and 148 includes a rate adapter 130, which reduces the bit rate of signals passing on to channel 120, and a modem 132 which establishes a voice band modem (VBM) connection with the modem 132 of the other gateway. The signals passing on channel 120 are optionally in a legal form of the 3G-324M standard, although having a lower signal rate than on the first and second segments 110 and 112. Alternatively, the signals passing on channel 120 are compressed or otherwise have a different format than the 3G-324M format.

The modem connection optionally includes only a data pump stage and not an error correction (EC) stage or a data compression (DC) stage, due to the real time nature of the video conferencing signals. The modem connection optionally overcomes the imparities of the PSTN, including one or more digital attenuation pads, robbed bit signaling and PCM clock timing problems. Alternatively, the modem uses an error correction (EC) stage, for example when a moderate delay (e.g., 0.1-1 seconds) is considered acceptable. In some embodiments of the invention, the modem also includes a data compression (DC) stage, for example, in those embodiments in which an error correction stage is used

The modem connection on channel 120 is optionally an all-digital modem connection (e.g., according to the V.91 recommendation), such that the modem connection has in both upstream and downstream directions a bit rate of close to 64 kbps. It is noted that an all-digital modem connection is achievable only when video device 150 (and gateway 148) is connected to PSTN 140 digitally and not through a twisted pair copper line or any other analog line. The cost of implementing an array of modems 132 at the interfaces between 3G network 106 and PSTN 140 was determined to be worthwhile, even if only 5-10% of the clients could use video device 150.

Alternatively, the modem connection on channel 120 is a digital to analog connection (i.e., link 120C is connected to gateway 148 or to video device 150 through an analog connection), allowing video device 150 to be used even if its connection to PSTN 140 is analog. Optionally, in accordance with this alternative, channel 120 has a bit rate of at least 40 Kbps or even 46 Kbps. The modem connection in accordance with this alternative is optionally according to V.90 or V.92 standards. In accordance with this alternative, a strong lossy rate adaptation mechanism is optionally used in order to fit the video conferencing signals in the bandwidth of the modem connection.

FIG. 2 is a flowchart of acts performed by rate adapter 130, in accordance with an exemplary embodiment of the invention. Rate adapter 130 optionally determines (202) the bit rate of the real time session of video conferencing signals passing onto channel 120. In addition, rate adapter 130 determines (204) the capacity of channel 120. The rate of the video signals is adapted (206) in order to fit into the capacity of the channel. In some embodiments of the invention, if (208) the channel capacity is too low for the bit rate of the real time session, the video conferencing connection is refused. Optionally, instead of the video conferencing connection, a regular telephone connection is established and modems 132 are not used. This option is used when a suitable quality of the video conferencing signals cannot be provided anyhow. Alternatively, a modem connection is established, the video conferencing signals are transmitted over the modem connection, but no rate adaptation is performed. Further alternatively, a connection is not established at all.

The channel capacity is optionally determined (208) to be too low, when the channel capacity is smaller than the signal rate of the video stream by more than 10%. Alternatively or additionally, the channel capacity is considered too small when the link (channel 120C) to video device 150 is analog.

In some embodiments of the invention, the determination (208) of whether the channel capacity is too low, is performed after the determination of the channel capacity and/or the bit rate of the session. Alternatively, the determination (208) is performed before the determination of the bit rate of the session and the channel capacity, for example when the determination is based on whether the connection is analog or digital. It is noted that the channel capacity and the session bit rate may be determined in any order or in parallel.

In some embodiments of the invention, the rate adaptation (206) includes dropping one or more frames, when required. For example, one out of every 24 frames may be dropped. As is known in the art, receivers operating according to the 3G-324M format know how to handle streams having missing frames. In these embodiments, the other end rate adapter 130 does not need to perform reverse rate adaptation acts to return the signals back to their original format.

Alternatively or additionally, the rate adaptation includes compressing some or all of the transmitted signals, for example reducing the size of headers of the transmitted video conferencing signals. In some embodiments of the invention, fields of the header which do not change between consecutive frames are dropped. Alternatively or additionally, frame sequence numbers in the headers are dropped or compressed and reconstructed at the other end. It is noted that the chances of data loss on a modem connection are much lower than on a cellular wireless link, and therefore the header protection required on the modem connection is much less than required by the 3G-324M standard. Further alternatively or additionally, the rate adaptation includes dropping error identification fields (e.g., CRC fields) and/or using a smaller field for error identification. Optionally, in accordance with this alternative, the other end rate adapter 130 performs decompression tasks required so that video device 150 and mobile unit 102 can use the video signals they receive.

In some embodiments of the invention, the rate adaptation (206) includes a standard data compression stage of the modem connection. Alternatively, the standard modem data compression (DC) stage is disabled or not implemented, for example if the video conferencing signals are sufficiently compressed and the modem compression is not expected to achieve substantial gain. In some embodiments of the invention, modem data compression is not used in order to limit the delay incurred by the modems 132 and/or the complexity of modems 132.

Determining (202) the bit rate of the video signals optionally includes determining whether all the portions of the video signal were received. If one or more portions of the video stream were lost, there may be no need to perform rate adaptation (206) or a weaker rate adaptation (e.g., less frame dropping), may be used. In other embodiments of the invention, however, an automatic dropping method is used for simplicity and every predetermined number of frames is dropped, regardless of whether packets were lost on their way to rate adapter 130.

The capacity of channel 120 is optionally determined (204) by modem 130 when the connection over channel 120 is established, using modem channel sensing methods known in the art.

It is noted that the use of modems 132 requires substantially lower amounts of processing resources than conversion of the video conferencing signals into IP packets.

Alternatively to performing the rate adaptation (206) in gateway 108, in some embodiments of the invention, the rate adaptation is performed closer to BTS 104, for example in a controller positioned in BTS 104 and/or in a base station controller (BSC) or in any other element of network 106.

In some embodiments of the invention, gateway 108 is part of a general gateway between cellular network 106 and PSTN 140. For each connection passing through gateway 108, the gateway determines whether it is a video connection. The video connections are handled using any of the methods described above, while other connections (e.g., voice and data connections) are handled using suitable methods for those connections. Alternatively, only video connections are transferred through gateway 108. In some embodiments of the invention, before establishing the connection, gateway 108 performs a fast procedure to determine whether the connection can be established, for example as described in the V.8b recommendation. Thus, a relatively lengthy connection procedure (e.g., a modem connection procedure) is not commenced until it has high success chances.

The above description relates to passage of video signals between a cellular network and a PSTN. It is noted, however, that the procedures of the present invention may be used with switched networks or emulated switched networks other than cellular networks. The present invention is especially useful for movement from networks having a capacity close to the capacity of the PSTN, around 64 Kbps, and/or for protocols that have bit rates slightly above the capacity of the PSTN.

It will be appreciated that the above described methods may be varied in many ways, including, changing the order of steps, and/or performing a plurality of steps concurrently. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. Many specific implementation details may be used. For example, gateway 108 may service a single video conferencing connection or may service a plurality of video conferencing connections. Furthermore, some aspects of the present invention are not limited to video conferencing and can be used with other video transmissions, such as video unicast or multicast services from video servers, multimedia messaging services and/or other video streaming services. For example, instead of connecting a mobile unit 102 to video device 150, embodiments of the present invention may be used to connect other video devices connected to terrestrial network 106 to device 150.

It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. Furthermore, the terms “comprise,” “include,” “have” and their conjugates, shall mean, when used in the claims, “including but not necessarily limited to.”

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims.

1. A method of handling video signals by a gateway, comprising:
receiving, by a gateway between a land cellular network and a public switched telephone network, video signals of a real time session, from an end unit;
reducing the rate of the video signals, by the gateway; and
transmitting the rate reduced video signals onto a channel passing through a public switched telephone network.

2. A method according to claim 1, wherein the received video signals are compressed by the end unit.

3. A method according to claim 1, wherein the received video signals have a bit rate greater than 46 Kbits per second.

4. A method according to claim 1, wherein the received video signals have a bit rate of about 64 Kbits per second.

5. A method according to claim 1, wherein the received video signals have a bit rate which can fit on the nominal bit rate of the public switched telephone network.

6. A method according to claim 1, wherein the end unit comprises a mobile unit.

7. A method according to claim 1, wherein the received video signals are in accordance with the 3G-324M standard.

8. A method according to claim 1, wherein reducing the rate of the video signals comprises dropping signal portions of the received video signals.

9. A method according to claim 1, wherein transmitting the rate reduced signals comprises transmitting over a channel suffering from at least one of digital attenuation pads, robbed bits and PCM clock skew.

10. A method according to claim 1, wherein reducing the rate of the video signals comprises compressing headers of packets of the video signals.

11. A method according to claim 1, wherein the received signals are in accordance with a standard format and the rate reduced signals are also according to the standard format.

12. A method according to claim 1, wherein the received signals are in accordance with a standard format and the rate reduced signals are not according to the standard format.

13. A method according to claim 1, wherein transmitting the rate reduced signals onto the channel comprises transmitting over a voice band modem connection.

14. A method according to claim 13, wherein transmitting the rate reduced signals comprises transmitting over an all digital modem connection over a PCM channel.

15. A method according to claim 1, wherein transmitting the rate reduced signals comprises transmitting over a non-dedicated channel of the public switched telephone network.

16. A method of handling video signals by a gateway, comprising:
receiving, by a gateway between a land cellular network and a public switched telephone network, video signals having a bit rate greater than 42 Kbps for both upstream and downstream transmissions; and
transmitting the video signals onto a modem connection passing through an all digital PCM link of a public switched telephone network.

17. A method according to claim 16, wherein the received video signals have a bit rate greater than 48 Kbps.

18. A method according to claim 16, comprising reducing the rate of the received video signals before transmitting the video signals on the modem connection.

19. A method according to claim 16, wherein transmitting the video signals onto a modem connection comprises transmitting on a V.91 modem connection.

20. A gateway to a public switched telephone network for video signals, comprising:
a video interface, for receiving video signals of a real time session;
a rate adaptation unit adapted to reduce the rate of the video signals received by the video interface; and
a PSTN interface for transmitting the reduced rate video signals onto a channel passing through a public switched telephone network PSTN.

21. A gateway according to claim 20, wherein the video interface is adapted to receive signals of the real time session at a rate greater than 33.6 Kbps in at least the upstream or downstream direction.

22. A gateway according to claim 20, wherein the video interface is adapted to receive signals in accordance with the 3G-324M standard.

23. A gateway according to claim 20, wherein the rate adaptation unit is adapted to drop video frames of the session.

24. A gateway according to claim 20, wherein the rate adaptation unit is adapted to increase the rate of video conferencing signals received through the PSTN interface and passed through the video interface.

25. A gateway according to claim 20, wherein the PSTN interface comprises a VBM modem.

26. A gateway according to claim 20, wherein the PSTN interface comprises an all-digital modem.

27. A gateway according to claim 20, wherein the video interface comprises an interface to a land cellular network.

28. A gateway according to claim 20, wherein the video interface comprises an interface to a private network.

29. A gateway according to claim 20, wherein the video interface is adapted to receive signals from a circuit switched emulated network.

30. A gateway according to claim 20, wherein the video interface is adapted to receive signals having a signal rate 1-20% greater than the actual capacity of the channel passing on the PSTN.

31. A gateway to a public switched telephone network for video signals, comprising:
a video interface, for receiving video signals of a real time session, at a rate greater than 42 Kbps;
a modem adapted to establish an all-digital connection over a PCM link of a public switched telephone network; and
a PSTN interface for transmitting the received video signals over the all-digital connection established by the modem.

32. A gateway according to claim 31, wherein the video interface receives signals at a rate greater than 48 Kbps.
